(19) United States
(12) Patent Application Publication
(10) Pub. No.: US 2025/0220083 A1
(43) Pub. Date: Jul. 3, 2025

(54) INTERNET CONTENT PROCESSING DEVICE/SYSTEM AND CORRESPONDING METHOD

(71) Applicant: Walter COPPO, Pontestura (Alessandria) (IT)

(72) Inventor: Walter COPPO, Pontestura (Alessandria) (IT)

(21) Appl. No.: 18/852,638

(22) PCT Filed: Mar. 27, 2023
(86) PCT No.: PCT/IB2023/052997

§ 371 Date: Sep. 30, 2024

(30) Foreign Application Priority Data
Mar. 29, 2022 (IT) 102022000006143

(51) Int. Cl. H04L 67/146; H04L 67/131

(52) U.S. Cl. CPC H04L 67/146; H04L 67/131

(57) ABSTRACT

Provided is an Internet content processing device having a control means arranged for receiving an Internet page request from a software application installed on a user device or running on a user device, downloading, from an Internet server, the Internet page indicated in the received Internet page request, making a modification to the downloaded Internet page, and sending to the user device the Internet page to which the modification has been made. An Internet content processing system and an Internet content processing method are also provided.

### TECHNICAL FIELD

The present invention relates, in general, to the field of Internet communications; in particular, the invention relates to an Internet content processing device, an Internet content processing system, and a corresponding method.

### PRIOR ART

Nowadays, the need to be able to make changes to an Internet page before it is delivered to a user device for use is becoming more and more apparent.

In the prior art, two approaches are known which may be used to make modifications to an Internet page:

### Approach A: Internet Server-Side Fusion

According to this first approach, described with reference to FIG. 1, the modification to be made to the Internet page is sent by the user device 100 to an Internet server 102. The Internet server 102 is set up to host one or more Internet pages of the site which must be integrated with the modification 104. These Internet pages are enriched by the Internet server 102 with the modification before being downloaded by the user device 100 via a communication channel 106 and subsequently displayed within a software application 108 of the user device 100.

Disadvantageously, the solution described above implies that the original logic that manages the Internet pages of the site is modified so that the modification itself may be integrated. Clearly, this solution is not efficient as it requires modifications and changes to the components of the Internet servers 102, which are designed for other purposes, introducing high costs for each external Internet page intended to be modified.

### Approach B: User Device-Side Fusion

This second approach, described with reference to FIG. 2, provides for the Internet page to be downloaded from an Internet server 202 locally into the user device 200 through a communication channel 206, as in a normal interaction with a browser. Locally, an application 208 executed on the user device 200 modifies the Internet page by adding/integrating the modification 204, for example in the form of a JavaScript routine.

The approach just described results in a considerable reduction of the impact of integrating the Internet pages, since the Internet servers 202 hosting them are free from any modification. However, this approach entails a strong impact at the level of development of the application software 208 on the user device 200, which will have to be in charge of all the operations of integration of the modification with the various Internet pages to be modified. This limit becomes too big an obstacle when this approach has to be performed by different software applications.

The need to modify the contents of Internet pages is of particular interest in the “in-game advertising” sector.

“In-game advertising” is a communication technique which tends to convey an advertising message within a video game, i.e. a software application.

This technique has become increasingly important with the advent of “mobile gaming”, i.e. the possibility of playing through modern user devices such as smartphones or tablets.

Such user devices are characterized by having sufficient processing and memory capacity and by being permanently connected to the Internet. These features allow the creation of software applications, e.g. video games, that are downloadable at low cost (often zero) and dynamic, i.e. with a game logic that varies over time and is controllable by external elements (game servers) and designed to involve multiple players (multiplayer).

The features listed above allow advertising messages to be conveyed in various forms:
by inserting multimedia content within the game screens; or
with the full-screen use of real promotional spots.

The logic of using these contents often provides a reward for the player in the form of elements essential to the logic of the game itself.

If on the one hand these techniques guarantee that the player benefits from the associated commercial message, on the other hand they sometimes disrupt the interaction dynamics of the game. Because of this, the player may shift his/her attention elsewhere while using the contents themselves, drastically reducing the effectiveness thereof in terms of communication.

To overcome this drawback, sometimes commercial communication is completely drowned in the game. On other occasions, it may happen that the game itself is built around the advertising message as in the case of commercial launches of new products. This approach is certainly more effective in terms of communication, but is characterized by being much more expensive.

### SUMMARY OF THE INVENTION

An object of the present invention is therefore to provide a solution that allows modifications to be made to an Internet page before the latter is provided to a user device for its use, which solution does not burden the computation and costs both on the Internet servers that manage the various Internet pages and on the user devices that will have to use these Internet pages.

The aforementioned and other objects and advantages are achieved according to a first aspect of the invention by an Internet content processing device having the features defined in claim 1, according to a second aspect of the invention by an Internet content processing system having the features defined in claim 7, and according to a third aspect of the invention by an Internet content processing method having the features defined in claim 14. Preferred embodiments of the invention are defined in the dependent claims, the content of which is to be understood as an integral part of the present description.

### BRIEF DESCRIPTION OF THE DRAWINGS

The functional and structural features of some preferred embodiments of an Internet content processing device, an Internet content processing system and an Internet content processing method according to the invention will now be described. Reference is made to the accompanying drawings, wherein:

FIG. 1 illustrates a first approach according to the prior art;

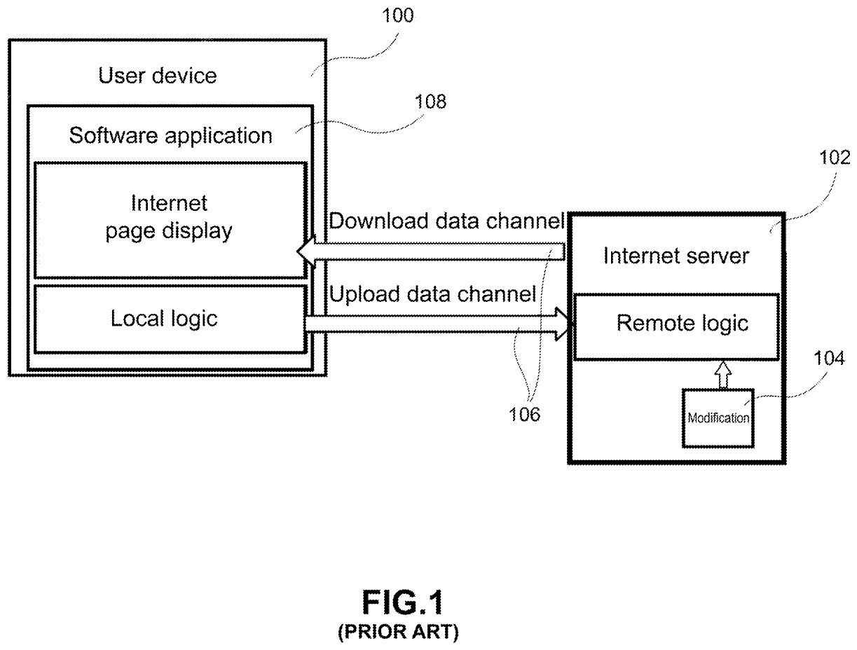

FIG. 2 illustrates a second approach according to the prior art;

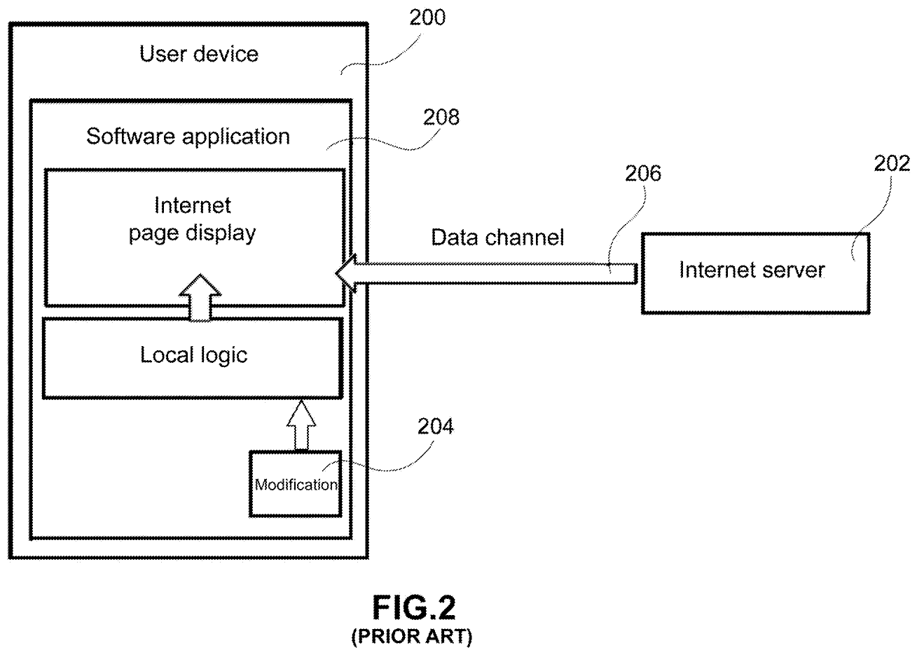

FIG. 3 illustrates an embodiment of an Internet content processing device according to the present invention;

FIG. 4 illustrates an example of modification to an Internet page;

FIG. 5 illustrates an embodiment of an Internet content processing system according to the present invention.

### DETAILED DESCRIPTION

Before explaining in detail a plurality of embodiments of the invention, it should be clarified that the invention is not limited in its application to the design details and configuration of the components presented in the following description or illustrated in the drawings. The invention may assume other embodiments and be implemented or constructed in practice in different ways. It should also be understood that the phraseology and terminology have a descriptive purpose and should not be construed as limiting. The use of “include” and “comprise” and the variations thereof are intended to cover the elements set out below and the equivalents thereof, as well as additional elements and the equivalents thereof.

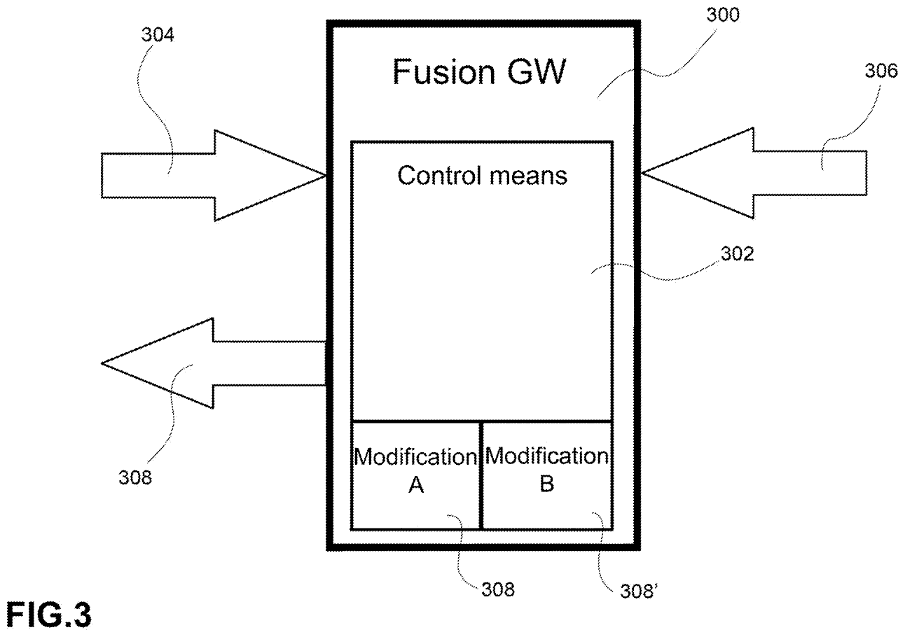

Referring initially to FIG. 3, an embodiment of an Internet content processing device 300 according to the invention is illustrated.

This Internet content processing device 300 includes a control means 302. The control means 302 is arranged for receiving an Internet page request 304 from a software application installed on a user device or running on a user device.

An Internet page request means a request for retrieval of an Internet page for its display on the user device.

Furthermore, the control means 302 is arranged for downloading, from an Internet server, the Internet page 306 indicated in the received Internet page request 304.

For example, it is possible to download the entire Internet page, in HTML JavaScript CSS format, over the HTTP/HTTPS protocol.

Furthermore, the control means 302 is arranged for making a modification 308 to said downloaded Internet page.

Still further, the control means is arranged for sending to said user device the Internet page to which the modification has been made, i.e. the modified Internet page.

Preferably, the control means 302 may be arranged for selecting the modification to be made to the Internet page from a plurality of predetermined modifications 308, 308′.

For example, the control means 302 may be or include at least one or more dedicated microprocessors, processors, coprocessors (e.g. RISC, FPGA, etc. . . . ).

Preferably, the selection of the modification to be made to the Internet page from the plurality of predetermined modifications 308, 308′ is performed according to a random logic. In other words, the modification may be done in a random way.

In another embodiment, preferably, each modification of the plurality of predetermined modifications 308, 308′ may be associated with a plurality of predetermined requirements. In this case, the control means 302 may also be arranged to verify which of the predetermined requirements are met by the Internet page, and to make to the Internet page the modification which has the greatest number of predetermined requirements satisfied by the Internet page.

In other words, the control means 302 will be able to select and make to the Internet page the modification which best suits the features of the Internet page itself.

For example, the predetermined requirements may be one or more of the following:
color Internet page;
scrollable Internet page;
Internet page including one or more images;
Internet page including one or more buttons.

Clearly, the Internet page may contain any type of content without limitations.

In a further embodiment, preferably, the selection of the modification to be made to the Internet page from the plurality of predetermined modifications 308, 308′ may be performed based on a user profile determined based on at least one of:
one or more machine learning algorithms;
one or more machine learning modules;
one or more combinatorial algorithms;
one or more classifier algorithms.

In other words, by means of user profiling, the control means 302 will be able to make the modification to the Internet page that best suits the user's needs and tastes.

Preferably, the control means 302 may be arranged to exclude from the selection one or more modifications of said plurality of predetermined modifications 308, 308′ when they have already been previously supplied to the same user device.

For example, the control means 302 may be arranged to store or receive memory information which allows it to determine whether a particular modification has already been made to an Internet page which was previously provided to the user device. In this way, it is possible to avoid a user being offered the same modification several times.

Preferably, the control means 302 may be arranged to make the modification to said downloaded Internet page by means of a machine learning or artificial intelligence technique.

The predetermined modifications 308, 308′ to be made to the Internet page may be, for example:
moving a particular content of the Internet page;
inserting/replacing/removing buttons;
inserting/replacing/removing images or videos;
inserting/removing audio;
inserting/replacing/removing texts.

The present invention is also advantageously applicable to the “in-game advertising” field, without increasing costs, and thereby minimizing investments.

Preferably, the modification to be made to the Internet page may be an insertion of a game logic into the Internet page.

For example, the game logic may be:
tracing tests of a particular content that is not related to the Internet page;
memory tests;
reflex tests;
color tests;
attention tests;
strategy tests.

The present invention, when applied to the “in-game advertising” field, allows the virtual boundaries within which a game logic takes place to be broken down, leading the user to play within Internet pages built to manage commercial communication of products. Therefore, it is no longer a question of having to build multimedia messages specifically designed to be enjoyed within games, but of modifying the normal Internet pages which are already entrusted with the official commercial communication of the brand or product in “playing fields”, i.e., cybernetic spaces in which the logic of the game mixes with the commercial message to be conveyed. All of this is obtained from a control means that is placed in the middle between a user device and an Internet server, consequently relieving the user device and the Internet server from further computational load and from the need to be modified.

The game logics, against a minimum management cost, may allow for a variability of behavior in keeping with the consolidated experience of the players.

In the following, by way of further clarification, some solutions that allow the modification of Internet pages are explained by way of example. In the first place, it is observed that the modern software architectures that characterize the latest-generation user devices are characterized by integrated languages and software elements that allow the creation of parts of the game in native languages of the Internet, e.g. HTML, CSS and JavaScript.

These parts, known as “web view”, may be inserted into software logics designed in other languages. This technique is certainly essential for building a game that may interact with Internet pages that are dynamically downloadable from the Internet servers that host them. It is therefore conceivable that this technique may be used as a technological enabler to achieve the fusion between game logic and traditional Internet pages. Furthermore, it should be added that it is now common practice to build Internet pages that adapt the display of their contents by optimizing it to the support that displays the contents themselves, in fact creating layouts suitably designed to have maximum effectiveness even on mobile user devices characterized by having a small screen size. The Internet contents, built to manage normal Internet communication, may be modified in the device itself, with the dynamic insertion of suitably designed game logics.

The Internet content processing device 300 that is the object of the present invention performs the function of a fusion network Gateway, “fusion GW”, where the embedding/fusion of a modification to be made to an Internet page and the Internet page itself, which may originally be resident on an Internet server, takes place.

The Internet content processing device 300 (fusion network gateway) is capable of forwarding the contents coming from the Internet servers which manage the various Internet pages. However, these pages are modified/enriched (for example with a game logic) before being transmitted to the various user devices.

As described above, the Internet content processing device 300, through the control means 302 (for example a modification logic management module—“Logic selector”), may select within a pool of possible modifications, for example the one most suitable for the modification itself and for the Internet page.

The Internet content processing device 300 of the present invention therefore offers the advantage of being scalable as the number of different modifications and Internet pages involved increases. The Internet content processing device 300 acts, in fact, as a decoupling layer between the software applications in the user devices and the Internet pages. Furthermore, being able to manage the insertion of modifications in a centralized manner, the Internet content processing device 300 allows transversal management modifications to be inserted to various software applications. To this it should be added that, in order to minimize the impact on the platform's operational management level, the Internet content processing device 300 may integrate consolidated machine learning and artificial intelligence techniques to guarantee a dynamic and captivating experience for the user.

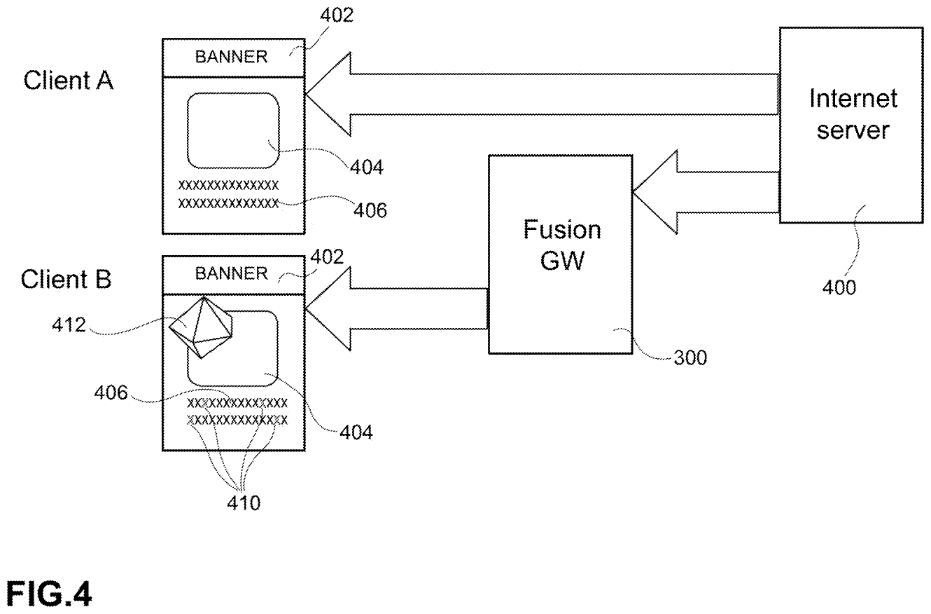

FIG. 4 shows an example of modification to an Internet page.

A standard web page, if accessed directly at the address of the source server 400, would appear with a banner 402, an image 404 and some text 406 (Client A). The same web page, if accessed through the intermediation of the Internet content processing device 300, i.e. the Fusion GW (Client B), in addition to appearing with the banner 402, the image 404 and the text 406, may be further enriched for example by seeing the text become a game based on color codes (in FIG. 4, the letters whose color has been changed are indicated with the reference numeral 410), the solution to which game returns, for example, a virtual diamond 412 as a prize, which may be, for example, an artifact necessary for other game logics related to other web pages.

A simple implementation of this type allows a logical thread transversal to completely related Internet pages to be defined, thus maximizing the player's experience and, above all, eliminating the need to modify the source pages.

In a further aspect, the present invention relates to an Internet content processing system.

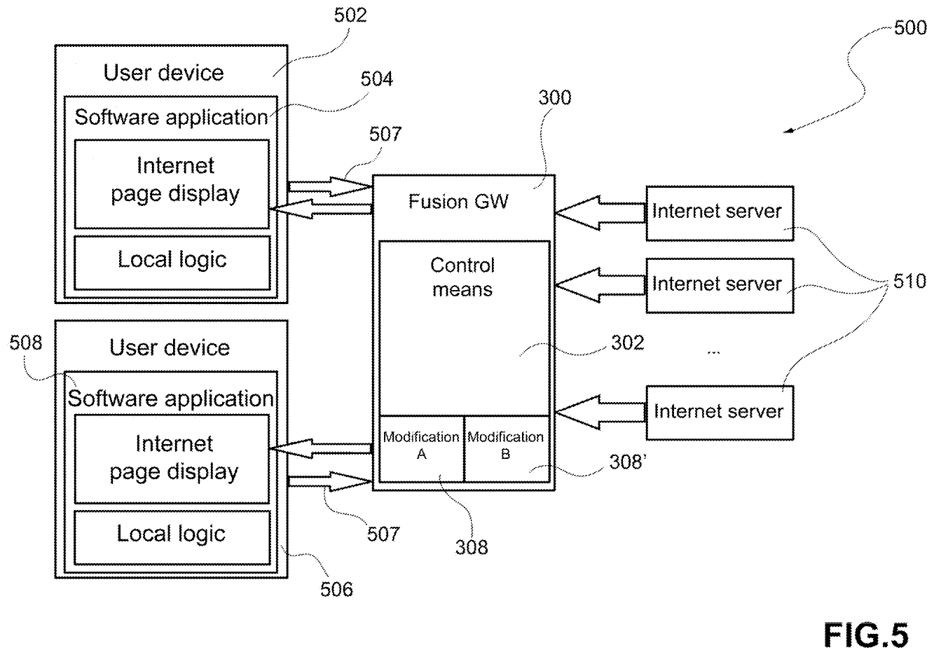

Referring to FIG. 5, this Internet content processing system 500 includes at least one user device 502 on which a software application 504 is installed or at least one user device 506 arranged to run a software application 508. The software application 504, 506 is arranged to issue an Internet page request 507.

The Internet content processing system 500 further includes at least one Internet server 510 associated with the Internet page indicated in the Internet page request.

Furthermore, the Internet content processing system 500 comprises an Internet content processing device 300 according to any one of the above-described embodiments.

As may be seen in FIG. 5, the Internet content processing device 300 may preferably be a distinct module, physically separate both from the at least one user device 502, 506 and from the at least one Internet server 510.

Preferably, the software application 504, 508 may be a videogame.

In this case, preferably, the software application 504, 508 may be arranged to send the Internet page request to the Internet content processing device 300 when the user reaches a predetermined step of the videogame.

In one embodiment, the step of the game may be, for example, a character in the videogame reaching a closed door. At that moment, the application software 504, 508 will be able to request an Internet page. The Internet page will be retrieved and modified (e.g. by inserting game logic) by the Internet content processing device 300. The modified page will be provided again to the user device 502, 506 to be shown to the user. The user will be able to solve the game logic. Once the game logic is solved, the user will be able to receive a reward. For example, the reward may be a software key or a code that will allow him/her to open the door and continue the videogame.

Preferably, the at least one user device 502, 506 may be at least one of a smartphone, a tablet, a computer, a wearable device, a videogame console, or the like.

Preferably, the at least one user device 502, 506 may be connected to the Internet content processing device 300 via a first communication network.

Preferably, the at least one Internet server 510 may be connected to the Internet content processing device 300 via a second communication network.

The first communication network may be a wireless network and/or the second communication network may be a wireless network.

In alternative embodiments, the first communication network may be a wired network and/or the second communication network may be a wired network.

In a last aspect, the invention also relates to an Internet content processing method.

The Internet content processing method is arranged to be performed by an Internet content processing device 300 according to any one of the embodiments described above. In particular, the Internet content processing method may be performed by the control means 302 of the Internet content processing device 300.

The Internet content processing method comprises the steps of:
receiving an Internet page request from a software application installed on a user device or running on a user device;
downloading, from an Internet server, the Internet page indicated in the received Internet page request;
making a modification to said downloaded Internet page;
sending to said user device the Internet page to which the modification has been made.

Different aspects and embodiments of an Internet content processing device, an Internet content processing system and an Internet content processing method according to the invention have been described. It is understood that each embodiment may be combined with any other embodiment. Moreover, the invention is not limited to the embodiments described, but may be varied within the scope defined by the appended claims.

1. An Internet content processing device including a control means arranged for:
receiving an Internet page request from a software application installed on a user device or running on a user device;
downloading, from an Internet server, the Internet page indicated in the received Internet page request;
making a modification to said downloaded Internet page; and
sending to said user device the Internet page to which the modification has been made.

2. The Internet content processing device of claim 1, wherein said control means is arranged to select the modification to be made to the Internet page from a plurality of predetermined modifications.

3. The Internet content processing device of claim 2, wherein:
the selection of the modification to be made to the Internet page from the plurality of predetermined modifications is performed according to a random logic; or
with each modification of the plurality of predetermined modifications a plurality of predetermined requirements is associated, wherein the control means is further arranged for:
a) verifying which of the predetermined requirements are met by the Internet page;
b) making to the Internet page the modification which has the greatest number of predetermined requirements satisfied by the Internet page; or,
the selection of the modification to be made to the Internet page from the plurality of predetermined modifications is performed based on a user profile determined based on at least one of:
one or more machine learning algorithms;
one or more machine learning modules;
one or more combinatorial algorithms;
one or more classifier algorithms.

4. The Internet content processing device of claim 2, wherein said control means is arranged to exclude from the selection one or more modifications of said plurality of predetermined modifications when they have already been previously provided to a same user device.

5. The Internet content processing device of claim 1, wherein said modification is an insertion of a game logic into the Internet page.

6. The Internet content processing device of claim 1, wherein said control means is arranged to make the modification to said downloaded Internet page by a machine learning or artificial intelligence technique.

7. An Internet content processing system including:
at least one user device on which a software application is installed or at least one user device arranged to run a software application, wherein said software application is arranged to issue an Internet page request;
at least one Internet server associated with the Internet page indicated in the Internet page request; and
the Internet content processing device of claim 1.

8. The Internet content processing system of claim 7, wherein the software application is a videogame.

9. The Internet content processing system of claim 8, wherein the software application is arranged to send the Internet page request to the Internet content processing device when a user reaches a predetermined step of the videogame.

10. The Internet content processing system of claim 7, wherein the at least one user device is at least one of:
a smartphone;
a tablet;
a computer;
a wearable device;
a videogame console.

11. The Internet content processing system of claim 7, wherein said at least one user device is connected to said Internet content processing device via a first communication network.

12. The Internet content processing system of claim 11, wherein said at least one Internet server is connected to said Internet content processing device via a second communication network.

13. The Internet content processing system of claim 12, wherein said first communication network is a wireless network and/or said second communication network is a wireless network.

14. An Internet content processing method arranged to be performed by the Internet content processing device of claim 1;
said Internet content processing method comprising of:
receiving an Internet page request from a software application installed on a user device or running on a user device;
downloading, from an Internet server, the Internet page indicated in the received Internet page request;
making a modification to said downloaded Internet page; and
sending to said user device the Internet page to which the modification has been made.
